(19) United States
(12) Patent Application Publication
(10) Pub. No.: US 2023/0220783 A1
(43) Pub. Date: Jul. 13, 2023

(54) POWER SOURCE FOR AN AIRCRAFT

(71) Applicant: General Electric Company, Schenectady, NY (US)

(72) Inventors: Honggang Wang, Clifton Park, NY (US); Di Pan, Schenectady, NY (US); Kum Kang Huh, Niskayuna, NY (US)

(21) Appl. No.: 17/571,652

(22) Filed: Jan. 10, 2022

(51) Int. Cl. F01D 15/10; F02C 3/30

(52) U.S. Cl. CPC F01D 15/10; F02C 3/30; F05D 2220/768; F05D 2240/35; F05D 2220/323; B64D 2221/00; B64D 2041/005

(57) ABSTRACT

A power source for an aircraft having a gas turbine engine, including: an electrical connection assembly; a fuel cell assembly integrated into the gas turbine engine, electrically coupled to the connection assembly and configured to provide a first power output; and an electric machine coupled to the gas turbine engine, electrically coupled to the connection assembly and configured to provide a second power output, wherein both the first power output from the fuel cell assembly and the second power output from the electric machine are provided to the connection assembly during operating of the gas turbine engine and wherein the connection assembly is electrically coupled to an aircraft electrical load.

### FIELD

The present disclosure relates to a power source for an aircraft and a method for providing power to an aircraft including a gas turbine engine, the power source including a connection assembly, a fuel cell providing a first power output, and an electric machine providing a second power output.

### BACKGROUND

The electrical power on a jet aircraft is usually provided from the generator(s) on the gas turbine engines and batteries, and in certain cases, the Auxiliary Power Unit (APU) or during a power interruption, when all other power sources have failed, a Ram Air Turbine (RAT). A mix of pneumatic, hydraulic, and electrical power is provided through generator(s), a hydraulic pump and compressor in the gas turbine engines or APU system.

In conventional aircraft, electric, hydraulic, and pneumatic power outputs are all dependent on the efficiency and capabilities of the jet turbine engines and APU system. Other forms of harnessing electrical, hydraulic, and pneumatic energy could improve the efficiency of the overall system in an aircraft.

A proton exchange membrane fuel cell (PEMFC) and a solid oxide fuel cell (SOFC) provide direct current (DC) electrical power from a chemical process. SOFC-GT is a SOFC/gas turbine engine hybrid where the unreacted byproducts from the SOFC such as oxygen and hydrogen can be utilized to within a combustion section of the gas turbine engine to increase the efficiency of the entire system to which it is electrically coupled.

Great portions of an aircraft's systems have been electrified resulting in an increase on the proportion of electrically driven loads replacing the traditional pneumatic or hydraulic loads. Traditionally, the engine driven electric machine has been the primary power source in the aircraft. Modern aircraft with increased aircraft electric loads within both the engine nacelle and the fuselage, require more distributed power sources to provide higher efficiency, reliability, and operational flexibility.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a perspective view of an integrated fuel cell and combustor assembly in accordance with the present disclosure.

FIG. 3 is a schematic, axial view of the exemplary integrated fuel cell and combustor assembly of FIG. 2.

FIG. 4 is a schematic view of a fuel cell of a fuel cell assembly in accordance with an exemplary aspect of the present disclosure as may be incorporated into the exemplary integrated fuel cell and combustor assembly of FIG. 2.

FIG. 5 is a schematic diagram of a gas turbine engine including an integrated fuel cell and combustor assembly in accordance with an exemplary aspect of the present disclosure.

FIG. 6 is a schematic view of a vehicle and propulsion system in accordance with an exemplary aspect of the present disclosure.

FIG. 7 is a schematic diagram of a power source in accordance with an exemplary aspect of the present disclosure.

FIG. 8 is a schematic diagram of a power source in accordance with another exemplary aspect of the present disclosure.

FIG. 9 is a schematic diagram of a power source in accordance with another exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” or “at least one of A, B, or C” refers to only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

A power source for an aircraft propulsion system with an engine, such as a gas turbine engine is provided. The power source includes an electrical connection assembly, a fuel cell assembly, and an electric machine. The fuel cell assembly is integrated into the gas turbine engine, electrically coupled to the connection assembly, and configured to provide a first power output. The electric machine is coupled to the gas turbine engine, electrically coupled to the connection assembly, and configured to provide a second power output. The first power output from the fuel cell assembly and the second power output from the electric machine are provided to the connection assembly during operating of the gas turbine engine and wherein the connection assembly is electrically coupled to an aircraft electrical load.

In another exemplary aspect of the present disclosure, an aircraft power source assembly is provided. The power source assembly includes a gas turbine engine including one or more accessory systems and a power source. The power source includes a connection assembly configured to electrically connect to the aircraft power bus. An engine power bus is electrically coupled to the connection assembly and configured to be integrated into the gas turbine engine. A fuel cell assembly is configured to be integrated into the gas turbine engine. The fuel cell assembly incudes a fuel cell group electrically coupled to the engine power bus and configured to provide a first power output to the engine power bus. An electric machine is configured to rotate with the gas turbine engine to generate a second power output during operation of the gas turbine engine when integrated into the gas turbine engine. The electric machine is electrically coupled to the connection assembly such that both the first power output from the fuel cell group and a second power output from the electric machine are provided to the connection assembly during operating of the gas turbine engine.

For example, the power source for an aircraft of the present disclosure may provide an additional power source for the aircraft to produce electrical power and provide increased flexibility in choice of power source for operation of the aircraft. The power source of the present disclosure may augment previously employed power sources. Moreover, the power source of the present disclosure may itself be configured to provide power output redundancy. As described below in more detail, the inventive power source may include a plurality of discrete fuel cell groups and each of which providing a power output that may be selectively coupled to more than one power bus, as required by aircraft and gas turbine engine operation. Thus, numerous aircraft systems may rely on more than one of the fuel cell groups based on need or on the failure of one of the fuel cell groups. In essence, the fuel cell groups may be configured as backups for each other and for other aircraft power sources.

In addition, the power source of the present disclosure may be configured to match the power output to the required load. Thus, the power source of the present disclosure may provide a DC power output with the required voltage for the load, potentially eliminating the need for a power converter. This results in an increase efficiency in terms of wiring and weight.

As will be discussed in more detail below, fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. To improve system efficiency and fuel utilization and reduce external water usage, the fuel cell system may include an anode recirculation loop. As a single fuel cell can only generate about 1V voltage, a plurality of fuel cells may be stacked together (which may be referred to as a fuel cell stack) to generate a desired voltage. Fuel cells may include Solid Oxide Fuel Cells (SOFC), Molten Carbonate Fuel Cells (MCFC), Phosphoric Acid Fuel Cells (PAFC), and Proton Exchange Membrane Fuel Cells (PEMFC), all generally named after their respective electrolytes.

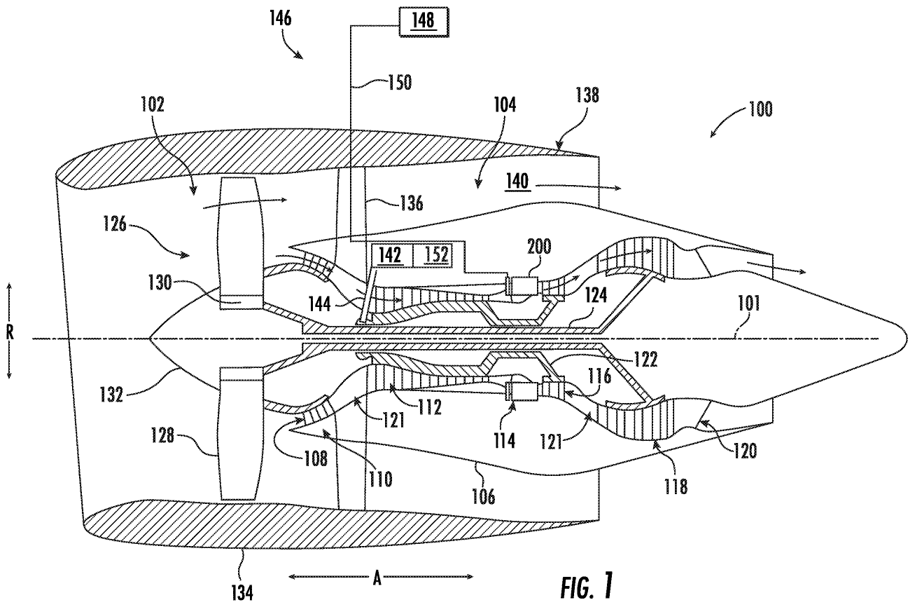

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable vehicle.

For the embodiment depicted, the engine is configured as a high bypass turbofan engine 100. As shown in FIG. 1, the turbofan engine 100 defines an axial direction A (extending parallel to a centerline axis 101 provided for reference), a radial direction R, and a circumferential direction (extending about the axial direction A; not depicted in FIG. 1). In general, the turbofan engine 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet nozzle exhaust section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The plurality of fan blades 128 and disk 130 are together rotatable about the centerline axis 101 by the LP shaft 124. The disk 130 is covered by a rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

In such a manner, it will be appreciated that turbofan engine 100 generally includes a first stream (e.g., core air flowpath 121) and a second stream (e.g., bypass airflow passage 140) extending parallel to the first stream. In certain exemplary embodiments, the turbofan engine 100 may further define a third stream extending, e.g., from the LP compressor 110 to the bypass airflow passage 140 or to ambient. With such a configuration, the LP compressor 110 may generally include a first compressor stage configured as a ducted mid-fan and downstream compressor stages. An inlet to the third stream may be positioned between the first compressor stage and the downstream compressor stages.

Referring still to FIG. 1, the turbofan engine 100 additionally includes an accessory gearbox 142 and a fuel delivery system 146. For the embodiment shown, the accessory gearbox 142 is located within the cowling/outer casing 106 of the turbomachine 104. Additionally, it will be appreciated that for the embodiment depicted schematically in FIG. 1, the accessory gearbox 142 is mechanically coupled to, and rotatable with, one or more shafts or spools of the turbomachine 104. For example, in the exemplary embodiment depicted, the accessory gearbox 142 is mechanically coupled to, and rotatable with, the HP shaft 122 through a suitable geartrain 144. The accessory gearbox 142 may provide power to one or more suitable accessory systems of the turbofan engine 100 during at least certain operations and may further provide power back to the turbofan engine 100 during other operations. For example, the accessory gearbox 142 is, for the embodiment depicted, coupled to a starter motor/generator 152. The starter motor/generator may be configured to extract power from the accessory gearbox 142 and turbofan engine 100 during certain operation to generate electrical power and may provide power back to the accessory gearbox 142 and turbofan engine 100 (e.g., to the HP shaft 122) during other operations to add mechanical work back to the turbofan engine 100 (e.g., for starting the turbofan engine 100).

Moreover, the fuel delivery system 146 generally includes a fuel source 148, such as a fuel tank, and one or more fuel delivery lines 150. The one or more fuel delivery lines 150 provide a fuel flow through the fuel delivery system 146 to the combustion section 114 of the turbomachine 104 of the turbofan engine 100. As will be discussed in more detail below, the combustion section 114 includes an integrated fuel cell and combustor assembly 200. The one or more fuel delivery lines 150, for the embodiment depicted, provide a flow of fuel to the integrated fuel cell and combustor assembly 200.

It will be appreciated, however, that the exemplary turbofan engine 100 depicted in FIG. 1 is provided by way of example only. In other exemplary embodiments, any other suitable gas turbine engine may be utilized with aspects of the present disclosure. For example, in other embodiments, the turbofan engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine, in other embodiments, a gas turbine engine of the present disclosure may be a geared gas turbine engine (i.e., including a gearbox between the fan 126 and a shaft driving the fan, such as the LP shaft 124), may be a variable pitch gas turbine engine (i.e., including a fan 126 having a plurality of fan blades 128 rotatable about their respective pitch axes), etc. Moreover, although the exemplary turbofan engine 100 includes a ducted fan 126, in other exemplary aspects, the turbofan engine 100 may include an unducted fan 126 (or open rotor fan), without the nacelle 134. Further, although not depicted herein, in other embodiments the gas turbine engine may be any other suitable type of gas turbine engine, such as a nautical gas turbine engine.

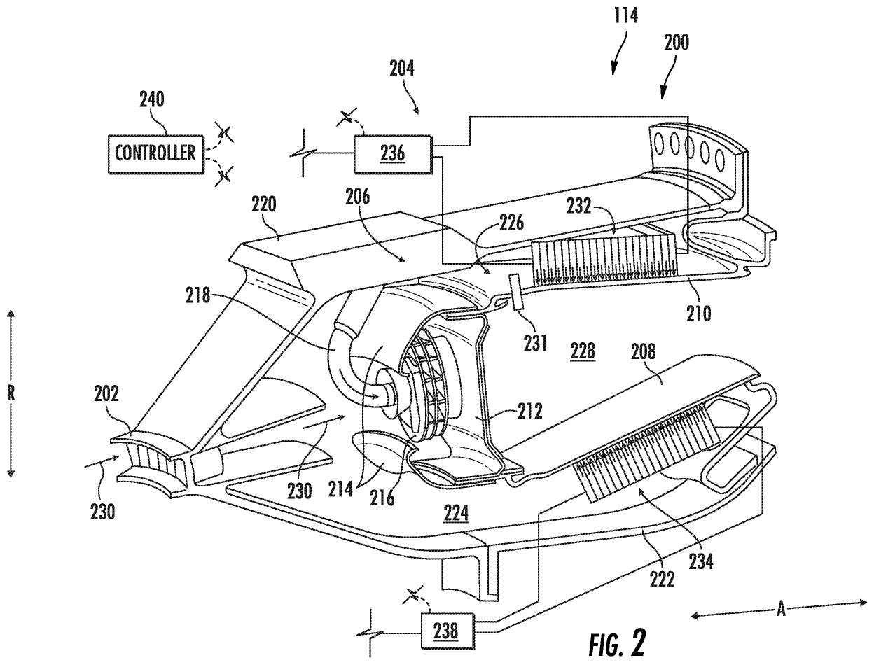

Referring now to FIG. 2, FIG. 2 illustrates schematically a portion of the combustion section 114 including a portion of the integrated fuel cell and combustor assembly 200 used in the gas turbine engine 100 of FIG. 1 (described as a turbofan engine 100 above with respect to FIG. 1), according to an embodiment of the present disclosure.

As will be appreciated, the combustion section 114 includes a compressor diffuser nozzle 202 and extends between an upstream end and a downstream end generally along the axial direction A. The combustion section 114 is fluidly coupled to the compressor section at the upstream end via the compressor diffuser nozzle 202 and to the turbine section at the downstream end.

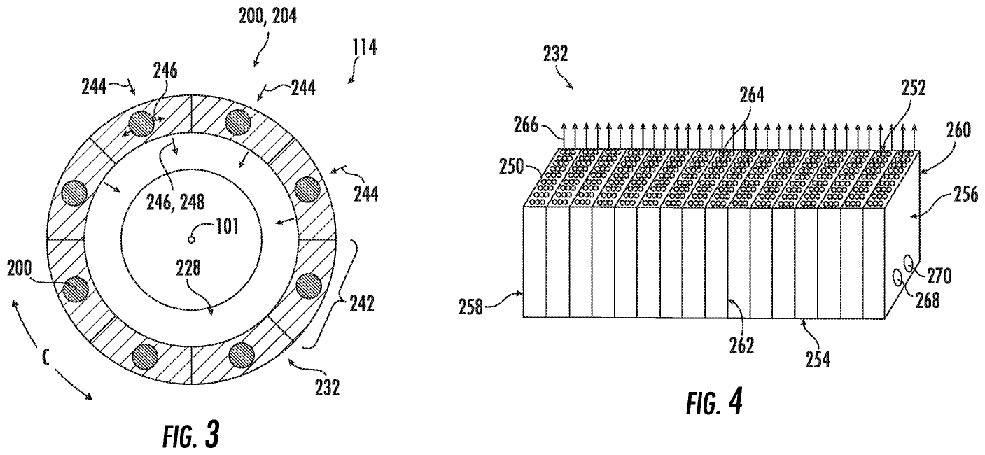

The integrated fuel cell and combustor assembly 200 generally includes a fuel cell assembly 204 (only partially depicted in FIG. 2; see also FIGS. 3 through 5) and a combustor 206. The combustor 206 includes an inner liner 208, an outer liner 210, a dome assembly 212, a cowl assembly 214, a swirler assembly 216, and a fuel flowline 218. The combustion section 114 generally includes an outer casing 220 outward of the combustor 206 along the radial direction R to enclose the combustor 206 and an inner casing 222 inward of the combustor 206 along the radial direction R. The inner casing 222 and inner liner 208 define an inner passageway 224 therebetween, and the outer casing 220 and outer liner 210 define an outer passageway 226 therebetween. The inner casing 222, the outer casing 220, and the dome assembly 212 together define at least in part a combustion chamber 228 of the combustor 206.

The dome assembly 212 is disposed proximate the upstream end of the combustion section 114 (i.e., closer to the upstream end than the downstream end) and includes an opening (not labeled) for receiving and holding the swirler assembly 216. The swirler assembly 216 also includes an opening for receiving and holding the fuel flowline 218. The fuel flowline 218 is further coupled to the fuel source 148 (see FIG. 1) disposed outside the outer casing 220 along the radial direction R and configured to receive the fuel from the fuel source 148. In such a manner, the fuel flowline 218 may be fluidly coupled to the one or more fuel delivery lines 150 described above with reference to FIG. 1.

The swirler assembly 216 can include a plurality of swirlers (not shown) configured to swirl the compressed fluid before injecting it into the combustion chamber 228 to generate combustion gas. The cowl assembly 214, in the embodiment depicted, is configured to hold the inner liner 208, the outer liner 210, the swirler assembly 216, and the dome assembly 212 together.

During operation, the compressor diffuser nozzle 202 is configured to direct a compressed fluid 230 from the compressor section to the combustor 206, where the compressed fluid 230 is configured to be mixed with fuel within the swirler assembly 216 and combusted within the combustion chamber 228 to generate combustion gasses. The combustion gasses are provided to the turbine section to drive one or more turbines of the turbine section (e.g., the high pressure turbine 116 and low pressure turbine 118).

During operation of the gas turbine engine 100 including the integrated fuel cell and combustor assembly 200, a flame within the combustion chamber 228 is maintained by a continuous flow of fuel and air. In order to provide for an ignition of the fuel and air, e.g., during a startup of the gas turbine engine 100, the integrated fuel cell and combustor assembly 200 further includes an ignitor 231. The ignitor 231 may provide a spark or initial flame to ignite a fuel and air mixture within the combustion chamber 228.

As mentioned above and depicted schematically in FIG. 2, the integrated fuel cell and combustor assembly 200 further includes the fuel cell assembly 204. The exemplary fuel cell assembly 204 depicted includes a first fuel cell stack 232 and a second fuel cell stack 234. More specifically, the first fuel cell stack 232 is configured with the outer liner 210 and the second fuel cell stack 234 is configured with the inner liner 208. More specifically, still, the first fuel cell stack 232 is integrated with the outer liner 210 and the second fuel cell stack 234 is integrated with the inner liner 208. Operation of the fuel cell assembly 204, and more specifically of a fuel cell stack (e.g., first fuel cell stack 232 or second fuel cell stack 234) of the fuel cell assembly 204 will be described in more detail below.

For the embodiment depicted, the fuel cell assembly 204 is configured as a solid oxide fuel cell (“SOFC”) assembly, with the first fuel cell stack 232 configured as a first SOFC fuel cell stack and the second fuel cell stack 234 configured as a second SOFC fuel cell stack (each having a plurality of SOFC's). As will be appreciated, a SOFC is generally an electrochemical conversion device that produces electricity directly from oxidizing a fuel. In generally, fuel cell assemblies, and in particular fuel cells, are characterized by an electrolyte material utilized. The SOFC's of the present disclosure may generally include a solid oxide or ceramic electrolyte. This class of fuel cells generally exhibit high combined heat and power efficiency, long-term stability, fuel flexibility, and low emissions.

Moreover, the exemplary fuel cell assembly 204 further includes a first power converter 236 and a second power converter 238. The first fuel cell stack 232 is in electrical communication with the first power converter 236 by a first plurality of power supply cables (not labeled), and the second fuel cell stack 234 is in electrical communication with the second power converter 238 by a second plurality of power supply cables (not labeled).

The first power converter 236 controls the electrical current drawn from the corresponding first fuel cell stack 232 and may convert the electrical power from a direct current (“DC”) power to either DC power at another voltage level or alternating current (“AC”) power. Similarly, the second power converter 238 controls the electrical current drawn from the second fuel cell stack 234 and may convert the electrical power from a DC power to either DC power at another voltage level or AC power. The first power converter 236, the second power converter 238, or both may be electrically coupled to an electric bus (such as the electric bus 326 described below).

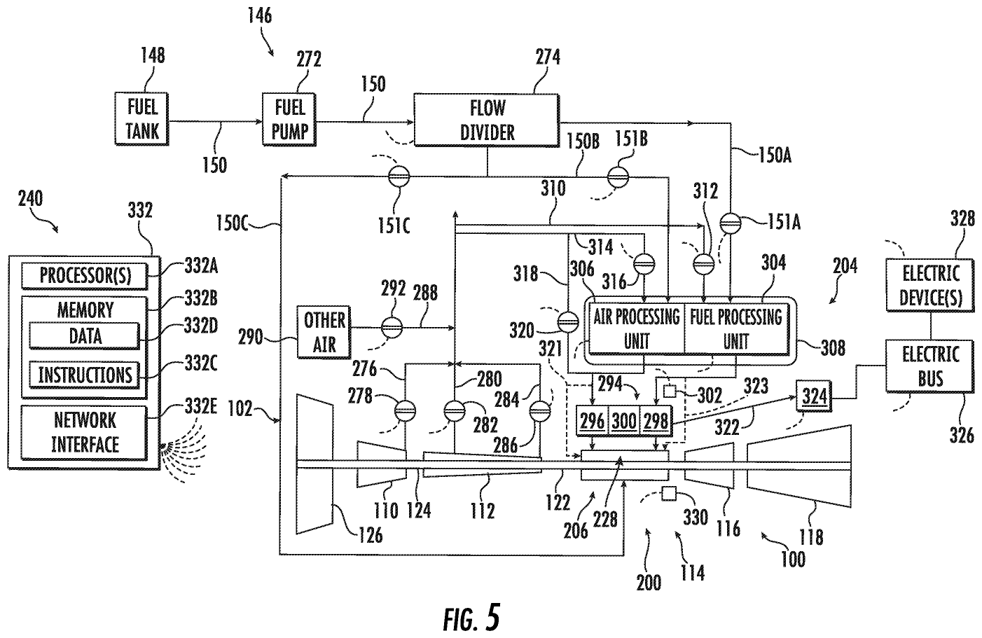

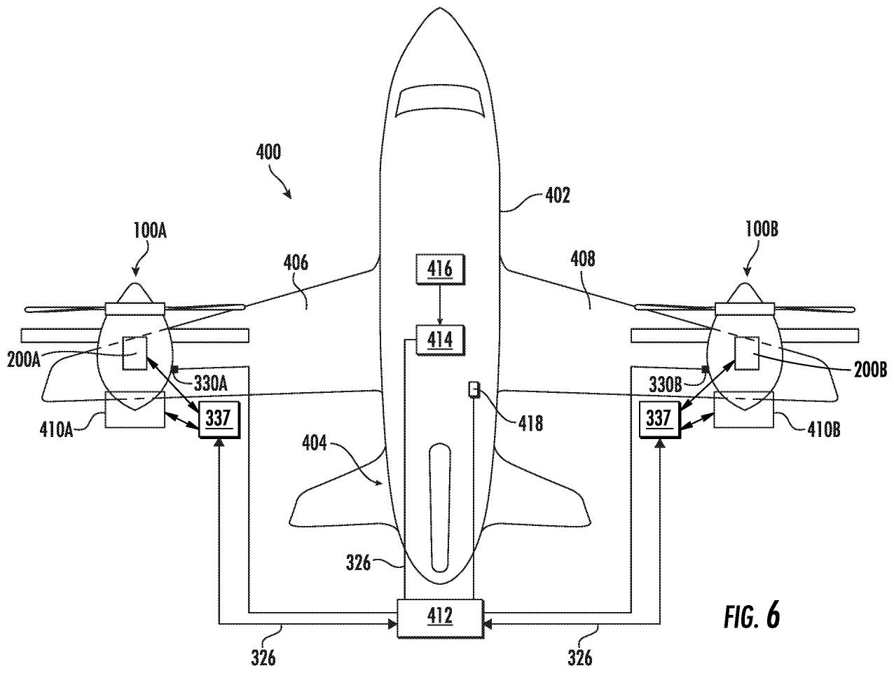

The integrated fuel cell and combustor assembly 200 further includes a fuel cell controller 240 that is in operable communication with both of the first power converter 236 and second power converter 238 to, e.g., send and receive communications and signals therebetween. For example, the fuel cell controller 240 may send current or power setpoint signals to the first power converter 236 and second power converter 238, and may receive, e.g., a voltage or current feedback signal from the first power converter 236 and second power converter 238. The fuel cell controller 240 may be configured in the same manner as the controller 240 described below with reference to FIG. 5.

It will be appreciated that in at least certain exemplary embodiments the first fuel cell stack 232, the second fuel cell stack 234, or both may extend substantially 360 degrees in a circumferential direction C of the gas turbine engine (i.e., a direction extending about the centerline axis 101 of the gas turbine engine 100). For example, referring now to FIG. 3, a simplified cross-sectional view of the integrated fuel cell and combustor assembly 200 is depicted according to an exemplary embodiment of the present disclosure. Although only the first fuel cell stack 232 is depicted in FIG. 3 for simplicity, the second fuel cell stack 234 may be configured in a similar manner.

As shown, the first fuel cell stack 232 extends around the combustion chamber 228 in the circumferential direction C, completely encircling the combustion chamber 228 around the centerline axis 101 in the embodiment shown. More specifically, the first fuel cell stack 232 includes a plurality of fuel cells 242 arranged along the circumferential direction C. The fuel cells 242 that are visible in FIG. 3 can be a single ring of fuel cells 242, with fuel cells 242 stacked together along the axial direction A (see FIG. 2) to form the first fuel cell stack 232. In another instance, multiple additional rings of fuel cells 242 can be placed on top of each other to form the first fuel cell stack 232 that is elongated along the centerline axis 101.

As will be explained in more detail, below, with reference to FIG. 5, the fuel cells 242 in the first fuel cell stack 232 are positioned to receive discharged air 244 from, e.g., the compressor section and fuel 246 from the fuel delivery system 146. The fuel cells 242 generate electrical current using this air 244 and at least some of this fuel 246, and radially direct partially oxidized fuel 246 and unused portion of air 248 into the combustion chamber 228 toward the centerline axis 101. The integrated fuel cell and combustor assembly 200 combusts the partially oxidized fuel 246 and air 248 in the combustion chamber 228 into combustion gasses that are directed downstream into the turbine section to drive or assist with driving the one or more turbines therein.

Moreover, referring now to FIG. 4, a schematic illustration is provided as a perspective view of the first fuel cell stack 232 of the integrated fuel cell and combustor assembly 200 of FIG. 2. The second fuel cell stack 234 may be formed in a similar manner.

The first fuel cell stack 232 depicted includes a housing 250 having a combustion outlet side 252 and a side 254 that is opposite to the combustion outlet side 252, a fuel and air inlet side 256 and a side 258 that is opposite to the fuel and air inlet side 256, and sides 260, 262. The side 260, the side 258, and the side 254 are not visible in the perspective view of FIG. 4.

As will be appreciated, the first fuel cell stack 232 may include a plurality of fuel cells that are “stacked,” e.g., side-by-side from one end of the first fuel cell stack 232 (e.g., fuel and air inlet side 256) to another end of the first fuel cell stack 232 (e.g., side 258). As such, it will further be appreciated that the combustion outlet side 252 includes a plurality of combustion outlets 264, each from a fuel cell of the first fuel cell stack 232. During operation, combustion gas 266 (also referred to herein as “output products”) is directed from the combustion outlets 264 out of the housing 250. As described herein, the combustion gas 266 is generated using fuel and air that is not consumed by the fuel cells inside the housing 250 of the first fuel cell stack 232. The combustion gas 266 is provided to the combustion chamber 228 and burned during operation to generate combustion gasses used to generate thrust for the gas turbine engine 100 (and vehicle/aircraft incorporating the gas turbine engine 100).

The fuel and air inlet side 256 includes one or more fuel inlets 268 and one or more air inlets 270. Optionally, one or more of the inlets 268, 270 can be on another side of the housing 250. Each of the one or more fuel inlets 268 is fluidly coupled with a source of fuel for the first fuel cell stack 232, such as one or more pressurized containers of a hydrogen-containing gas or a fuel processing unit as described further below. Each of the one or more air inlets 270 is fluidly coupled with a source of air for the fuel cells, such as air that is discharged from a compressor section and/or an air processing unit as is also described further below. The one or more inlets 268, 270 separately receive the fuel and air from the external sources of fuel and air, and separately direct the fuel and air into the fuel cells.

In certain exemplary embodiments, the first fuel cell stack 232 of FIGS. 2 through 4 may be configured in a similar manner to one or more of the exemplary fuel cell systems (labeled 100) described in, e.g., U.S. Patent Application Publication No. 2020/0194799 A1, filed Dec. 17, 2018, that is incorporated by reference herein in its entirety. It will further be appreciated that the second fuel cell stack 234 of FIG. 2 may be configured in a similar manner as the first fuel cell stack 232, or alternatively may be configured in any other suitable manner.

It will be appreciated that, fuel cell assembly 204 of the present disclosure is divided into a plurality of fuel cell groups, with each fuel cell group capable of producing a discrete power output. As used herein, the term “group” as it relates to a fuel cell group of a fuel cell assembly refers to a plurality of fuel cells joined in a manner that may allow for electrical power to be outputted by the plurality of fuel cells separately from any other fuel cells of the fuel cell assembly during at least certain operations. For example, in the embodiment of FIG. 2, the first fuel cell stack 232 may be a first fuel cell group and the second fuel cell stack 234 may be a second fuel cell group. Alternatively, however, the fuel cell assembly 204 may include a plurality of fuel cell groups arranged along a length of the outer liner 210 along the axial direction A, a plurality of fuel cell groups arranged circumferentially along the outer liner 210 along the circumferential direction C, or a combination thereof. Separate power cables may be provided for each fuel cell group.

Further, it will be appreciated that although the exemplary fuel cell assembly 204 of FIGS. 2 through 4 generally includes the fuel cells, e.g., the fuel cells of the first fuel cell stack 232 and the second fuel cell stack 234, arranged along and integrated with the outer and inner liners 210, 208 of the combustor 206, in other embodiments, the fuel cell assembly 204 may be configured in any other suitable manner, in any other suitable location (e.g., axially forward of the combustor 206, spaced outward of the combustor 206 along the radial direction R, etc.). Further, in other embodiments, the fuel cell assembly 204 may use a chemistry other than solid oxide chemistry.

Referring now to FIG. 5, operation of an integrated fuel cell and combustor assembly 200 in accordance with an exemplary embodiment of the present disclosure will be described. More specifically, FIG. 5 provides a schematic illustration of a gas turbine engine 100 and an integrated fuel cell and combustor assembly 200 according to an embodiment of the present disclosure. The gas turbine engine 100 and integrated fuel cell and combustor assembly 200 may, in certain exemplary embodiments, be configured in a similar manner as one or more of the exemplary embodiments of FIGS. 1 through 4.

Accordingly, it will be appreciated that the gas turbine engine 100 generally includes a fan section 102 having a fan 126, an LP compressor 110, an HP compressor 112, a combustion section 114, an HP turbine 116, and an LP turbine 118. The combustion section 114 generally includes the integrated fuel cell and combustor assembly 200 having a combustor 206 and a fuel cell assembly 204.

A propulsion system including the gas turbine engine 100 further includes a fuel delivery system 146. The fuel delivery system 146 generally includes a fuel source 148 and one or more fuel delivery lines 150. The fuel source 148 may include a supply of fuel (e.g., a hydrocarbon fuel, including, e.g., a carbon-neutral fuel or synthetic hydrocarbons) for the gas turbine engine 100. In addition, it will be appreciated that the fuel delivery system 146 also includes a fuel pump 272 and a flow divider 274, and the one or more fuel delivery lines 150 include a first fuel delivery line 150A, a second fuel delivery line 150B, and a third fuel delivery line 150C. The flow divider 274 divides the fuel flow from the fuel source 148 and fuel pump 272 into a first fuel flow through the first fuel delivery line 150A to the fuel cell assembly 204, a second fuel flow through the second fuel delivery line 150B also to the fuel cell assembly 204 (and in particular to an air processing unit, described below), and a third fuel flow through a third fuel delivery line 150C to the combustor 206. The flow divider 274 may include a series of valves (not shown) to facilitate such dividing of the fuel flow from the fuel source 148, or alternatively may be of a fixed geometry. Additionally, for the embodiment shown, the fuel delivery system 146 includes a first fuel valve 151A associated with the first fuel delivery line 150A (e.g., for controlling the first fuel flow), a second fuel valve 151B associated with the second fuel delivery line 150B (e.g., for controlling the second fuel flow), and a third fuel valve 151C associated with the third fuel delivery line 150C (e.g., for controlling the third fuel flow).

The gas turbine engine 100 further includes a compressor bleed system and an airflow delivery system. More specifically, the compressor bleed system includes an LP bleed air duct 276 and an associated LP bleed air valve 278, an HP bleed air duct 280 and an associated HP bleed air valve 282, an HP exit air duct 284 and an associated HP exit air valve 286.

The gas turbine engine 100 further includes an air stream supply duct 288 (in airflow communication with an airflow supply 290) and an associated air valve 292, which is also in airflow communication with the airflow delivery system for providing compressed airflow to the fuel cell assembly 204 of the integrated fuel cell and combustor assembly 200. The airflow supply may be, e.g., a second gas turbine engine configured to provide a cross-bleed air, an auxiliary power unit (APU) configured to provide a bleed air, a ram air turbine (RAT), etc. The airflow supply may be complimentary to the compressor bleed system if the compressor air source is inadequate or unavailable.

The compressor bleed system (and air stream supply duct 288) is in airflow communication with airflow delivery system for providing compressed airflow to the fuel cell assembly 204, as will be explained in more detail below.

Referring still to FIG. 5, the fuel cell assembly 204 of the integrated fuel cell and combustor assembly 200 includes a fuel cell stack 294, which may be configured in a similar manner as, e.g., the first fuel cell stack 232 described above. The fuel cell stack 294 is depicted schematically as a single fuel cell having a cathode side 296, an anode side 298, and an electrolyte 300 positioned therebetween. As will generally be appreciated, the electrolyte 300 may, during operation, conduct negative oxygen ions from the cathode side 296 to the anode side 298 to generate an electric current and electric power.

Briefly, it will be appreciated that the fuel cell assembly 204 further includes a fuel cell sensor 302 configured to sense data indicative of a fuel cell assembly operating parameter, such as a temperature of the fuel cell stack 294 (e.g., of the cathode side 296 or anode side 298 of the fuel cell), a pressure within the fuel cell stack 294 (e.g., of within the cathode side 296 or anode side 298 of the fuel cell).

The anode side 298 may support electrochemical reactions that generate electricity. A fuel may be oxidized in the anode side 298 with oxygen ions received from the cathode side 296 via diffusion through the electrolyte 300. The reactions may create heat, steam, and electricity in the form of free electrons in the anode side 298, which may be used to supply power to an energy consuming device (such as the one or more additional electric devices 328 described below). The oxygen ions may be created via an oxygen reduction of a cathode oxidant using the electrons returning from the energy consuming device into the cathode side 296.

The cathode side 296 may be coupled to a source of the cathode oxidant, such as oxygen in the atmospheric air. The cathode oxidant is defined as the oxidant that is supplied to the cathode side 296 employed by the fuel cell system in generating electrical power. The cathode side 296 may be permeable to the oxygen ions received from the cathode oxidant.

The electrolyte 300 may be in communication with the anode side 298 and the cathode side 296. The electrolyte 300 may pass the oxygen ions from the cathode side 296 to the anode side 298, and may have little or no electrical conductivity, so as to prevent passage of the free electrons from the cathode side 296 to the anode side 298.

The anode side of a solid oxide fuel cell (such as the fuel cell stack 294) may be composed of a nickel/yttria-stabilized zirconia (Ni/YSZ) cermet. Nickel in the anode side serves as a catalyst for fuel oxidation and current conductor. During normal operation of the fuel cell stack 294, the operating temperature may be greater than or equal to about 700° C., and the nickel (Ni) in the anode remains in its reduced form due to the continuous supply of primarily hydrogen fuel gas.

The fuel cell stack 294 is disposed downstream of the LP compressor 110, the HP compressor 112, or both. Further, as will be appreciated from the description above with respect to FIG. 2, the fuel cell stack 294 may be coupled to or otherwise integrated with a liner of the combustor 206 (e.g., an inner liner 208 or an outer liner 210). In such a manner, the fuel cell stack 294 may also be arranged upstream of a combustion chamber 228 of the integrated fuel cell and combustor assembly 200, and further upstream of the HP turbine 116 and LP turbine 118.

As shown in FIG. 5, the fuel cell assembly 204 also includes a fuel processing unit 304 and an air processing unit 306. The fuel processing unit 304 may be any suitable structure for generating a hydrogen rich fuel stream. For example, the fuel processing unit 304 may include a fuel reformer or a catalytic partial oxidation convertor (CPOx) for developing the hydrogen rich fuel stream for the fuel cell stack 294. The air processing unit 306 may be any suitable structure for raising the temperature of air that is provided thereto to a temperature high enough to enable fuel cell temperature control (e.g., about 600° C. to about 800° C.). For example, in the embodiment depicted, the air processing unit includes a preburner system, operating based on a fuel flow through the second fuel delivery line 150B, configured for raising the temperature of the air through combustion, e.g., during transient conditions such as startup, shutdown and abnormal situations.

In the exemplary embodiment depicted, the fuel processing unit 304 and air processing unit 306 are manifolded together within a housing 308 to provide conditioned air and fuel to the fuel cell stack 294.

It should be appreciated, however, that the fuel processing unit 304 may additionally or alternatively include any suitable type of fuel reformer, such as an autothermal reformer and steam reformer that may need an additional stream of steam inlet with higher hydrogen composition at the reformer outlet stream. Additionally, or alternatively, still, the fuel processing unit 304 may include a reformer integrated with the fuel cell stack 294. Similarly, it should be appreciated that the air processing unit 306 of FIG. 5 could alternatively be a heat exchanger or another device for raising the temperature of the air provided thereto to a temperature high enough to enable fuel cell temperature control (e.g., about 600° C. to about 800° C.).

As mentioned above, the compressor bleed system (and air stream supply duct 288) is in airflow communication with airflow delivery system for providing compressed airflow to the fuel cell assembly 204. The airflow delivery system includes an anode airflow duct 310 and an associated anode airflow valve 312 for providing an airflow to the fuel processing unit 304, a cathode airflow duct 314 and associated cathode airflow valve 316 for providing an airflow to the air processing unit 306, and a cathode bypass air duct 318 and an associated cathode bypass air valve 320 for providing an airflow directly to the fuel cell stack 294 (or rather to the cathode side 296 of the fuel cell(s)). The fuel delivery system 146 is configured to provide the first flow of fuel through the first fuel delivery line 150A to the fuel processing unit 304, and the second flow of fuel through the second fuel delivery line 150B to the air processing unit 306 (e.g., as fuel for a preburner system, if provided).

The fuel cell stack 294 outputs the power produced as a fuel cell power output 322. Further, the fuel cell stack 294 directs a cathode air discharge and an anode fuel discharge (neither labeled for clarity purposes) into the combustion chamber 228 of the combustor 206.

In operation, the air processing unit 306 is configured to heat/cool a portion of the compressed air, incoming through the cathode airflow duct 314, to generate a processed air to be directed into the fuel cell stack 294 to facilitate the functioning of the fuel cell stack 294. The air processing unit 306 receives the second flow of fuel from the second fuel delivery line 150B and may, e.g., combust such second flow of fuel to heat the air received to a desired temperature (e.g., about 600° C. to about 800° C.) to facilitate the functioning of the fuel cell stack 294. The air processed by the air processing unit 306 is directed into the fuel cell stack 294. In an embodiment of the disclosure, as is depicted, the cathode bypass air duct 318 and the air processed by the air processing unit 306 may combine into a combined air stream to be fed into a cathode 552 of the fuel cell stack 294.

Further, as shown in the embodiment of FIG. 5, the first flow of fuel through the first fuel delivery line 150A is directed to the fuel processing unit 304 for developing a hydrogen rich fuel stream (e.g., optimizing a hydrogen content of a fuel stream), to also be fed into the fuel cell stack 294. As will be appreciated, and as discussed below, the flow of air (processed air and bypass air) to the fuel cell stack 294 (e.g., the cathode side 296) and fuel from the fuel processing unit 304 to the fuel cell stack 294 (e.g., the anode side 298) may facilitate electrical power generation.

Because the inlet air for the fuel cell stack 294 may come solely from the upstream compressor section without any other separately controlled air source, it will be appreciated that the inlet air for the fuel cell stack 294 discharged from the compressor section is subject to the air temperature changes that occur at different flight stages. By way of illustrative example only, the air within a particular location in the compressor section of the gas turbine engine 100 may work at 200° C. during idle, 600° C. during take-off, 268° C. during cruise, etc. This type of temperature change to the inlet air directed to the fuel cell stack 294 may lead to significant thermal transient issues (or even thermal shock) to the ceramic materials of the fuel cell stack 294, which could range from cracking to failure.

Thus, by fluidly connecting the air processing unit 306 between the compressor section and the fuel cell stack 294, the air processing unit 306 may serve as a control device or system to maintain the air processed by the air processing unit 306 and directed into the fuel cell stack 294 within a desired operating temperature range (e.g., plus or minus 100° C., or preferably plus or minus 50° C., or plus or minus 20° C.). In operation, the temperature of the air that is provided to the fuel cell stack 294 can be controlled (relative to a temperature of the air discharged from the compressor section) by controlling the flow of fuel to the air processing unit 306. By increasing a fuel flow to the air processing unit 306, a temperature of the airflow to the fuel cell stack 294 may be increased. By decreasing the fuel flow to the air processing unit 306, a temperature of the airflow to the fuel cell stack 294 may be decreased. Optionally, no fuel can be delivered to the air processing unit 306 to prevent the air processing unit 306 from increasing and/or decreasing the temperature of the air that is discharged from the compressor section and directed into the air processing unit 306.

Moreover, as is depicted in phantom, the fuel cell assembly 204 further includes an airflow bypass duct 321 extending around the fuel cell 294 to allow a portion or all of an airflow conditioned by the air processing unit 306 (and combined with any bypass air through duct 318) to bypass the cathode side 296 of the fuel cell 294 and go directly to the combustion chamber 228. The airflow bypass duct 321 may be in thermal communication with the fuel cell 294. The fuel cell assembly further includes a fuel bypass duct 323 extending around the fuel cell 294 to allow a portion or all of a reformed fuel from the fuel processing unit 304 to bypass the anode side 298 of the fuel cell 294 and go directly to the combustion chamber 228.

As briefly mentioned above, the fuel cell stack 294 converts the anode fuel stream from the fuel processing unit 304 and air processed by the air processing unit 306 sent into the fuel cell stack 294 into electrical energy, the fuel cell power output 322, in the form of DC current. This fuel cell power output 322 is directed to a power convertor 324 in order to change the DC current into DC current or AC current that can be effectively utilized by one or more subsystems. In particular, for the embodiment depicted, the electrical power is provided from the power converter to an electric bus 326. The electric bus 326 may be an electric bus dedicated to the gas turbine engine 100, an electric bus of an aircraft incorporating the gas turbine engine 100, or a combination thereof. The electric bus 326 is in electric communication with one or more additional electrical devices 328, which may be adapted to draw an electric current from, or apply an electrical load to, the fuel cell stack 294. The one or more additional electrical devices 328 may be a power source, a power sink, or both. For example, the additional electrical devices 328 may be a power storage device (such as one or more batteries), an electric machine (an electric generator, an electric motor, or both), an electric propulsion device, etc. For example, the one or more additional electric devices 328 may include the starter motor/generator of the gas turbine engine 100.

Referring still to FIG. 5, the gas turbine engine 100 further includes a sensor 330. In the embodiment shown, the sensor 330 is configured to sense data indicative of a flame within the combustion section 114 of the gas turbine engine 100. The sensor 330 may be, for example, a temperature sensor configured to sense data indicative of an exit temperature of the combustion section 114, an inlet temperature of the turbine section, an exhaust gas temperature, or a combination thereof. Additionally, or alternatively, the sensor 330 may be any other suitable sensor, or any suitable combination of sensors, configured to sense one or more gas turbine engine operating conditions or parameters, including data indicative of a flame within the combustion section 114 of the gas turbine engine 100.

Moreover, as is further depicted schematically in FIG. 5, the propulsion system, an aircraft including the propulsion system, or both, includes a controller 240. For example, the controller 240 may be a standalone controller, a gas turbine engine controller (e.g., a full authority digital engine control, or FADEC, controller), an aircraft controller, supervisory controller for a propulsion system, a combination thereof, etc.

The controller 240 is operably connected to the various sensors, valves, etc. within at least one of the gas turbine engine 100 and the fuel delivery system 146. More specifically, for the exemplary aspect depicted, the controller 240 is operably connected to the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302. As will be appreciated from the description below, the controller 240 may be in wired or wireless communication with these components. In this manner, the controller 240 may receive data from a variety of inputs (including the gas turbine engine sensor 330 and the fuel cell sensor 302), may make control decisions, and may provide data (e.g., instructions) to a variety of output (including the valves of the compressor bleed system to control an airflow bleed from the compressor section, the airflow delivery system to direct the airflow bled from the compressor section, and the fuel delivery system 146 to direct the fuel flow within the gas turbine engine 100).

Referring particularly to the operation of the controller 240, in at least certain embodiments, the controller 240 can include one or more computing device(s) 332. The computing device(s) 332 can include one or more processor(s) 332A and one or more memory device(s) 332B. The one or more processor(s) 332A can include any suitable processing device, such as a microprocessor, microcontroller, integrated circuit, logic device, and/or other suitable processing device. The one or more memory device(s) 332B can include one or more computer-readable media, including, but not limited to, non-transitory computer-readable media, RAM, ROM, hard drives, flash drives, and/or other memory devices.

The one or more memory device(s) 332B can store information accessible by the one or more processor(s) 332A, including computer-readable instructions 332C that can be executed by the one or more processor(s) 332A. The instructions 332C can be any set of instructions that when executed by the one or more processor(s) 332A, cause the one or more processor(s) 332A to perform operations. In some embodiments, the instructions 332C can be executed by the one or more processor(s) 332A to cause the one or more processor(s) 332A to perform operations, such as any of the operations and functions for which the controller 240 and/or the computing device(s) 332 are configured, the operations for operating a propulsion system (e.g., method 600), as described herein, and/or any other operations or functions of the one or more computing device(s) 332. The instructions 332C can be software written in any suitable programming language or can be implemented in hardware. Additionally, and/or alternatively, the instructions 332C can be executed in logically and/or virtually separate threads on processor(s) 332A. The memory device(s) 332B can further store data 332D that can be accessed by the processor(s) 332A. For example, the data 332D can include data indicative of power flows, data indicative of gas turbine engine 100/aircraft operating conditions, and/or any other data and/or information described herein.

The computing device(s) 332 also includes a network interface 332E configured to communicate, for example, with the other components of the gas turbine engine 100 (such as the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302), the aircraft incorporating the gas turbine engine 100, etc. The network interface 332E can include any suitable components for interfacing with one or more network(s), including for example, transmitters, receivers, ports, controllers, antennas, and/or other suitable components. In such a manner, it will be appreciated that the network interface 332E may utilize any suitable combination of wired and wireless communications network(s).

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It will be appreciated that the gas turbine engine 100, the exemplary fuel delivery system 146, the exemplary integrated fuel cell and combustor assembly 200, and the exemplary fuel cell assembly 204 are provided by way of example only. In other embodiments, the integrated fuel cell and combustor assembly 200 and fuel cell assembly 204 may have any other suitable configuration. For example, in other exemplary embodiments, the fuel cell assembly 204 may include any other suitable fuel processing unit 304. Additionally, or alternatively, the fuel cell assembly 204 may not require a fuel processing unit 304, e.g., when the combustor of the gas turbine engine 100 is configured to burn hydrogen fuel and the fuel delivery assembly 146 is configured to provide hydrogen fuel to the integrated fuel cell and combustor assembly 200, and in particular to the fuel cell assembly 204.

As briefly mentioned above, the fuel cell assembly 204 may be in electrical communication with the electric bus 326, which may be an electric bus of the gas turbine engine 100, of an aircraft, or a combination thereof. Referring now briefly to FIG. 6, a schematic view is provided of an aircraft 400 in accordance with an embodiment of the present disclosure including one or more gas turbine engines 100 (labeled 100A and 100B), each with an integrated fuel cell and combustor assembly 200 (labeled 200A and 200B), and an aircraft electric bus 326 in electrical communication with the one or more gas turbine engines 100.

In particular, for the exemplary embodiment depicted, the aircraft 400 is provided including a fuselage 402, an empennage 404, a first wing 406, a second wing 408, and a propulsion system. The propulsion system generally includes a first gas turbine engine 100A coupled to, or integrated with, the first wing 406 and a second gas turbine engine 100B coupled to, or integrated with, the second wing 408. It will be appreciated, however, that in other embodiments, any other suitable number and or configuration of gas turbine engines 100 may be provided (e.g., fuselage-mounted, empennage-mounted, etc.).

The first gas turbine engine 100A generally includes a first integrated fuel cell and combustor assembly 200A and a first electric machine 410A. The first integrated fuel cell and combustor assembly 200A may generally include a first fuel cell assembly. The first electric machine 410A may be an embedded electric machine, an offset electric machine (e.g., rotatable with the gas turbine engine 100 through an accessory gearbox or suitable geartrain), etc. For example, in certain exemplary embodiments, the first electric machine 410A may be a starter motor/generator for the first gas turbine engine 100A.

Similarly, the second gas turbine engine 100B generally includes a second integrated fuel cell and combustor assembly 200B and a second electric machine 410B. The second integrated fuel cell and combustor assembly 200B may generally include a second fuel cell assembly. The second electric machine 410B may also be an embedded electric machine, an offset electric machine (e.g., rotatable with the gas turbine engine 100 through an accessory gearbox or suitable geartrain), etc. For example, in certain exemplary embodiments, the second electric machine 410B may be a starter motor/generator for the second gas turbine engine 100B.

In the embodiment of FIG. 6, the aircraft 400 additionally includes the electric bus 326 and a supervisory controller 412. Further, it will be appreciated that the aircraft 400 and/or propulsion system includes one or more electric devices 414 and an electric energy storage unit 416, each in electric communication with the electric bus 326. The electric devices 414 may represent one or more aircraft power loads (e.g., avionics systems, control systems, electric propulsors, etc.), one or more electric power sources (e.g., an auxiliary power unit), etc. The electric energy storage unit 416 may be, e.g., a battery pack or the like for storing electric power.

The electric bus 326 further electrically connects to the first electric machine 410A and first fuel cell assembly, as well as to the second electric machine 410B and second fuel cell assembly. The supervisory controller 412 may be configured in a similar manner as the controller 240 of FIG. 5 or may be in operative communication with a first gas turbine engine controller dedicated to the first gas turbine engine 100A and a second gas turbine engine controller dedicated to the second gas turbine engine 100B.

In such a manner, it will be appreciated that the supervisory controller 412 may be configured to receive data from a gas turbine engine sensor 330A of the first gas turbine engine 100A and from a gas turbine engine sensor 330B of the second gas turbine engine 100B and may further be configured to send data (e.g., commands) to various control elements (such as valves) of the first and second gas turbine engines 100A, 100B.

Moreover, it will be appreciated that for the embodiment depicted, the aircraft 400 includes one or more aircraft sensor(s) 418 configured to sense data indicative of various flight operations of the aircraft 400, including, e.g., altitude, ambient temperature, ambient pressure, airflow speed, etc. The supervisory controller 412 is operably connected to these aircraft sensor(s) 418 to receive data from such aircraft sensor(s) 418.

In addition to receiving data from sensors 330A, 330B, 418 and sending data to control elements, the supervisory controller 412 is configured to control a flow of electric power through the electric bus 326. For example, the supervisory controller 412 may be configured to command and receive a desired power extraction from one or more of the electric machines (e.g., the first electric machine 410A and second electric machine 410B), one or more of the fuel cell assemblies (e.g., the first fuel cell assembly and second fuel cell assembly), or both, and provide all or a portion of the extracted electric power to other of the one or more of the electric machines (e.g., the first electric machine 410A and second electric machine 410B), one or more of the fuel cell assemblies (e.g., the first fuel cell assembly and second fuel cell assembly), or both. One or more of these actions may be taken in accordance with the logic outlined below.

In one embodiment, fuel cell assembly 204 of each integrated fuel cell and combustor assembly 200 (labeled 200A and 200B; see also FIGS. 2 through 5) is divided into a plurality of fuel cell groups, with each fuel cell group producing a discrete power output. For example, the first fuel cell stack 232 may be configured as a first fuel cell group with a first power output and the second fuel cell stack 234 may be configured as a second fuel cell group with a second power output. The first and second fuel cell groups may be arranged on the outer and inner liners 210, 208 of the combustor 206 (as in FIG. 2), may be arranged axially along one of the outer or inner liners 210, 208 of the combustor 206, may be arranged circumferentially along one or both of the outer or inner liners 210, 208 of the combustor 206, or may be arranged in any other suitable manner. Further, in other embodiments, the fuel cell assembly 204 may include more than two groups (e.g., 3, 4, 5, or more groups, such as up to 20 groups).

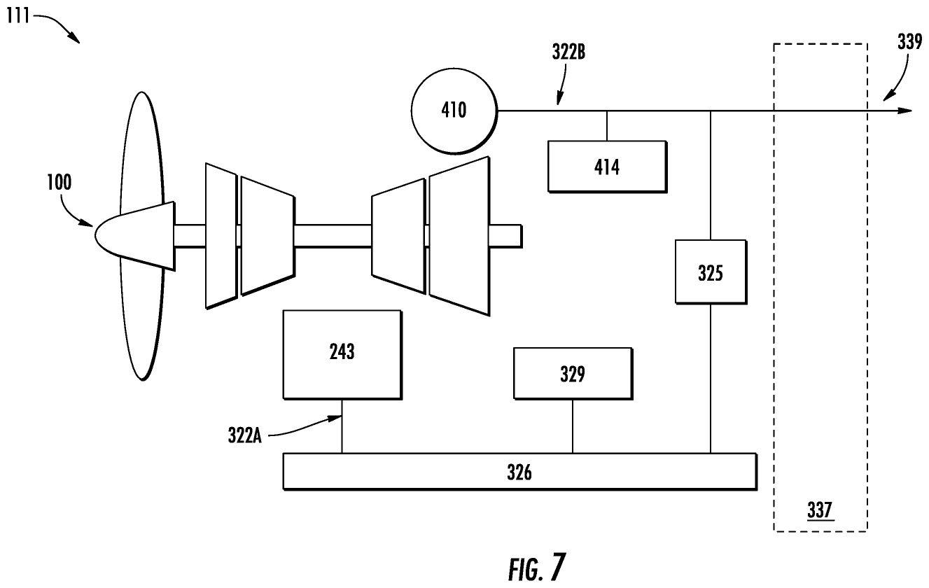

Referring now to FIGS. 7 through 9, a power source 111 is provided including a connection assembly 337 configured to electrically connect to the aircraft power bus (not shown), a fuel cell assembly (not shown) associated with a gas turbine engine 100, and an electric machine 410 configured to rotate with the gas turbine engine 100. The fuel cell assembly (not shown) includes a fuel cell group 243 electrically coupled to an electric bus 326, also referred to as an engine power bus, and configured to provide a first power output 322A to the engine power bus 326. The electric machine 410 is configured generate a second power output 322B during operation of the gas turbine engine 100 when integrated into the gas turbine engine 100. The first power output 322A may be a DC power output and the second power output 322B may be an AC power output.

The electric machine 410 may be electrically coupled to the connection assembly 337 such that both the first power output 322A from the fuel cell group 243 and the second power output 322B from the electric machine 410 are provided to the connection assembly 337 during operating of the gas turbine engine 100.

The fuel cell assembly (not shown) may be configured in a similar manner as the exemplary fuel cell assembly 204 of FIGS. 2 through 5, and the gas turbine engine 100 may be configured in a similar manner as the exemplary gas turbine engine 100 of FIG. 1. For example, the gas turbine engine 100 generally includes a casing (which may be the nacelle 134 or the casing 106; see FIG. 1). In the embodiment of FIG. 7, the casing is referred to as the nacelle (not shown). It will be appreciated, however, that in other embodiments, the casing may instead be the casing (not shown) of the gas turbine engine 100. Although not depicted, both the fuel cell assembly (and fuel cell group 243) and electric machine 410 are positioned within the casing of the gas turbine engine 100.

In certain exemplary aspects, the electric machine 410 may be configured in a similar manner as the exemplary starter motor/generator 152 of FIG. 1. Additionally, or alternatively, the electric machine 410 may be mechanically coupled to a high pressure system of the gas turbine engine 100 (not labeled, see HP compressor 112 and HP turbine 116 of FIG. 1), to a low pressure system of the gas turbine engine 100 (not labeled, see LP compressor 110 and LP turbine 118 of FIG. 1), to an intermediate speed system (not shown), or some combination thereof. The electric machine 410 may be a single electric machine or may be a plurality of electric machines. The electric machine 410 may be an embedded electric machine located inward of a core air flowpath (e.g., see flowpath 121 of FIG. 1) of the gas turbine engine 100 (e.g., within the compressor section or turbine section), or may be offset from a central axis and connected through a suitable gear train. In an embodiment, the engine power bus 326 is a DC power bus and the engine power bus 326 distributes power to a plurality of accessory systems 329 of the gas turbine engine 100 when integrated into the gas turbine engine 100. In certain embodiments, the plurality of accessory systems 329 are independently selected from an engine control unit, a starter, a compressor, a pump, a de-icing system, a motor, and a combination thereof.

In the embodiment of FIG. 7, the connection assembly 337 comprises a single output line. As used herein, the term “single output line” refers to one set of electrical lines (e.g., one set of three phase electric lines, or one set of positive and negative electric lines). More specifically, for the embodiment depicted, the single output line is an AC output line 339. Additionally, the power source 111 includes a converter 325 configured as a DC/AC converter, wherein the engine power bus 326 is electrically coupled to the connection assembly 337 with the DC/AC converter 325. More specifically, for the embodiment of FIG. 7, the engine power bus 326 (and first power output 322A) and electric machine 410 (and second power output 322B) are in electrical communication with one another through the converter 325 such that the first power output 322A (or a portion thereof) may be combined with the second power output 322B (or a portion thereof).

For this embodiment, the engine power bus 326 (and first power output 322A) and electric machine 410 (and second power output 322B) are more specifically in electrical communication with one another at a location upstream of the single output line, and more specifically of the AC output line 339, such that the AC output line 339 is configured to receive a combined power output from the engine power bus 326 (and first power output 322A) and electric machine 410 (and second power output 322B).

The converter 325 may be a full power converter or a partial power converter (as described in U.S. Pat. No. 9,809,119 (which is incorporated herein by this reference)). The converter 325 may be a bidirectional converter, used to realize the “power transfer” inside the engine 100 between the integrated fuel cell and electric machines. In some examples, the bidirectional AC/DC converter 325 may transfer power from the electric machine 410 to the engine DC loads (e.g., accessory systems 329), when the fuel cell is not active, or when the fuel cell is not producing sufficient power to meet the engine DC load demand. In this case, the total system power via the AC output line 339 is the second power output 322B by electric machine 410 minus the AC loads 414 and the power transferred to the engine DC loads via the converter 325. In other examples, the bidirectional AC/DC converter 325 may transfer the DC power from the fuel cell or the engine DC bus to the AC line/bus, wherein the DC power may be supplemental power to the electric machine, and the electric machine may be working in a generator mode or motor mode. When the electric machine works in the generator mode, the fuel cell is providing additional electrical generation capability or unburdening the electric machine (as a generator) and engine spool. In this case, the total system power output via AC output line 339 is the second power output 322B by electric machine 410 plus the power transferred to the AC line/bus from the fuel cell or the engine DC bus. When the electric machine works in the motor mode, the power from the fuel cell be transferred to the engine spools via the electric machine (operating in the motor mode) for, e.g., improved engine transient operability usage. In this case, the total system power output via the AC output line 339 is the power transferred to the AC line/bus from the fuel cell or the engine DC bus via the converter 325, minus the second power consumption 322B by electric machine 410 in motor mode and the power consumption by the AC load 414.

This electrical configuration design may improve the system availability with redundancy when either fuel cell or electrical machine fails. Also, the AC connection assembly has higher compatibility with existing aircraft, with less retrofitting effort for system integration. Another benefit of the AC connection assembly is that the AC protection is relatively simpler than DC.

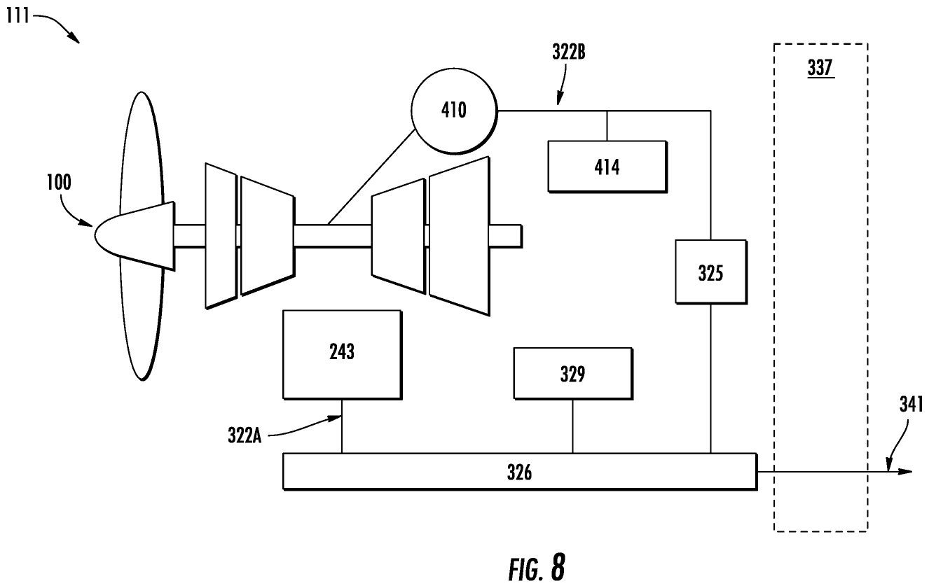

Referring now to FIG. 8, the power source 111 is configured in a similar manner as the exemplary power source of FIG. 7. In the embodiment of FIG. 8, the connection assembly 337 again includes a single output line. However, for the embodiment of FIG. 8, the single output line is a DC output line 341, and instead of the converter 325 being an DC/AC converter, the converter 325 of the power source 111 is configured as an AC/DC converter, wherein the electric machine 410 is electrically coupled to the connection assembly 337 through the converter 325 and through the engine power bus 326. More specifically, for the embodiment of FIG. 8, electric machine 410 (and second power output 322B) and the engine power bus 326 (and first power output 322A) are in electrical communication with one another through the converter 325 such that the second power output 322B (or a portion thereof) may be combined with the first power output 322A (or a portion thereof).

As with the embodiment of FIG. 7, for the embodiment of FIG. 8, the engine power bus 326 (and first power output 322A) and electric machine 410 (and second power output 322B) are more specifically in electrical communication with one another at a location upstream of the single output line, and more specifically of the DC output line 341, such that the DC output line 341 is configured to receive a combined power output from the engine power bus 326 (and first power output 322A) and electric machine 410 (and second power output 322B).

As with the embodiment of FIG. 7, for the embodiment of FIG. 8, the converter 325 may be a bidirectional converter. In some examples, the bidirectional AC/DC converter 325 may transfer power from the electric machine 410 to the engine DC loads, when the fuel cell 243 is not active, or the fuel cell 243 is not producing sufficient power to meet the engine DC load demand. In this case, the total system power output via DC output line 341 is the second power output 322B by electric machine 410 in generation mode minus the power transferred to the engine DC loads (e.g., accessory systems 329). In other examples, the bidirectional AC/DC converter 325 may transfer power from the electric machine 410 to the engine power bus 326, also referred to herein as an engine DC bus, as a supplemental power to the fuel cell power. In this case, the total system power output via DC output line 341 is the power transfer to the engine DC bus 326 via the bidirectional AC/DC converter 325 plus fuel cell power output 322A. In yet another example, the bidirectional AC/DC converter 325 may transfer the DC power from the fuel cell 243 or the engine DC bus 326 to the AC line/bus (receiving the power output 322B), wherein the DC power may be supplemental power to the electric machine 410 working as motoring mode. In this case, the total system power output via DC output line 341 is the DC power output of the DC bus 326, such as from the fuel cell 243, minus the power transferred to the AC line/bus from the fuel cell 243 and/or the engine DC bus 326.

This DC interconnect configuration design in FIG. 8 may reduce the distribution cable weight since the DC cable design may be lighter than the AC counterpart. However, the protection design for the DC interconnect may be more complicated than the AC interconnect in FIG. 7. Also, there may need to be more retrofitting work in the short term since at least certain existing aircraft distribution systems are primary AC based systems.

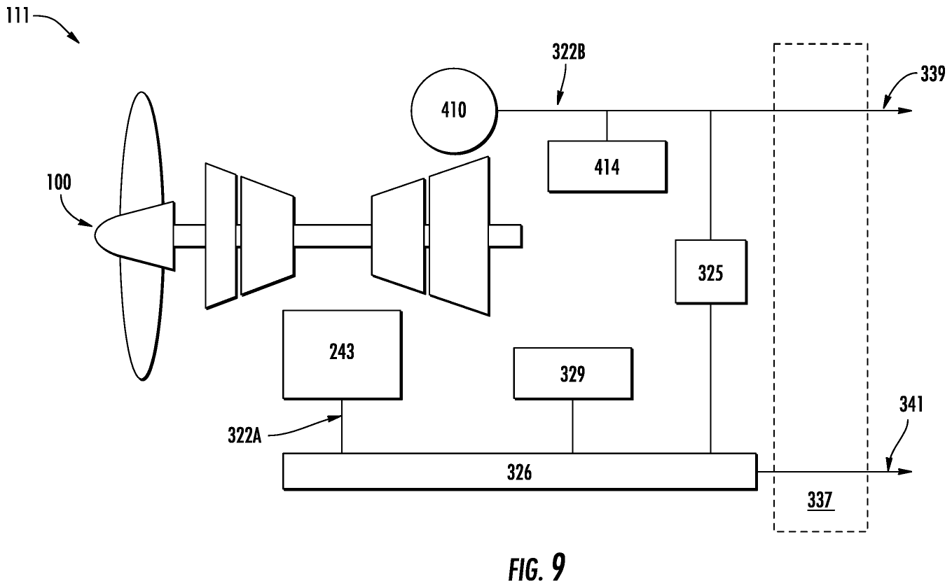

Referring now to FIG. 9, the power source 111 is also configured in a similar manner as the exemplary power source of FIG. 7. However, in the embodiment of FIG. 9, the connection assembly 337 includes multiple output lines, and more specifically includes an AC output line 339 and a DC output line 341. The electric machine 410 is electrically coupled to the aircraft power bus (not shown) through the AC output line 339 of the connection assembly 337 and the engine power bus 326 is electrically coupled to the aircraft power bus (not shown) through the DC output line 341 of the connection assembly 337.

In certain embodiments, the second power output 322B provides power to one or more aircraft accessory systems external to the gas turbine engine 100 (e.g., electronic devices 414, see FIG. 6). In another embodiment, the aircraft power bus (not shown) is electrically coupled to one or more loads external to the engine (not shown). (See generally FIG. 6.)

As with the embodiment of FIG. 7, for the embodiment of FIG. 9, the converter 325 may be a bidirectional converter. In some examples, the bidirectional AC/DC converter 325 may transfer power from the electric machine 410 to the engine DC loads (e.g., accessory system 329), when the fuel cell 243 is not active, or the fuel cell 243 is not producing sufficient power to meet the engine DC load demand. In other examples, the bidirectional AC/DC converter 325 may transfer power from the electric machine 410 to the engine DC bus 326, as a supplemental power to the fuel cell power. In yet another example, the bidirectional AC/DC converter 325 may transfer the DC power from the fuel cell 243 or the engine DC bus 326 to the AC line/bus (receiving the power output 322B), wherein the DC power may be supplemental power to the electric machine 410 working as motoring mode.

The power transfer between the engine DC bus 326 and/or fuel cell 243 and the AC line or electric machine 410 may also be performed via the aircraft distribution system (at the right hand side of the AC output line 339 and the DC output line 341, not shown). This is due to the improved flexibility introduced by the interconnect with multiple output lines, as shown with the embodiment of FIG. 9. With such a configuration, although not depicted, the high power converter 325 may be relocated from the engine nacelle, which may generally be a relatively harsh environment, to the fuselage (easier design of converter due to more friendly environment in fuselage). With such a configuration, the AC/DC converter in the engine can be simplified to a passive rectifier.

In embodiments, the power source 111 may include one or more controllers (not shown) electrically coupled to the fuel cell group 243 and the electric machine 410 to control allocation of power from the fuel cell group 243 and the electrical machine. The one or more controllers may be configured in a similar manner to the controller 240 of FIG. 2 or 5. In such a manner, it will further be appreciated that the one or more controllers may be configured to control one or more fuel cell operating conditions to, inter alia, modify the first power output 322A, the second power output 322B, or both.

In an embodiment, the fuel cell assembly 204 is a solid oxide fuel cell assembly, and the gas turbine engine 100 includes a combustion section in which fuel cells include an outlet positioned to provide output products from the fuel cell to the combustion section (see, e.g., FIGS. 2 through 5).

In certain embodiments, the power source 111 further includes an energy storage system (not shown), such as a battery, electrically coupled to the engine power bus 326, which can provide power to the engine power bus 326 or be recharged by the fuel cell group 243 through the engine power bus 326, as needed. Further, in certain embodiments, the power source 111 also includes an alternative power source (not shown) electrically coupled to the engine power bus 326. In embodiments, the alternative power source may include an auxiliary power unit, additional fuel cell groups, a power output from another power bus, or the like. Further, in other embodiments, the power storage system (not shown) or the auxiliary power source (not shown) may operate on AC power, and therefore the power source 111 may include an AC/DC power converter (not shown) to connect to the engine power bus 326.

As will further be appreciated, the power system may include switches (not shown) to selectively connect one or more of the fuel cell group 243, the electric machine 410, the engine power bus 326, the connection assembly 337, and the aircraft power bus (not shown). The controller 240 may be operably connected to one or more of these switches to selectively electrically connect these components in response to, e.g., various sensed data, control decisions, or the like.

Further aspects are provided by the subject matter of the following clauses:

A power source for an aircraft having a gas turbine engine, comprising: an electrical connection assembly; a fuel cell assembly integrated into the gas turbine engine, electrically coupled to the connection assembly and configured to provide a first power output; and an electric machine coupled to the gas turbine engine, electrically coupled to the connection assembly and configured to provide a second power output, wherein both the first power output from the fuel cell assembly and the second power output from the electric machine are provided to the connection assembly during operating of the gas turbine engine and wherein the connection assembly is electrically coupled to an aircraft electrical load.

The power source of one or more of these clauses, wherein the connection assembly electrically coupled to a power bus, wherein the power bus distributes power to the aircraft electrical load.

The power source of one or more of these clauses, wherein the power bus is a DC power bus and wherein the electric machine is electrically coupled to the DC power bus through an AC/DC converter, wherein the AC/DC converter is bidirectional AC/DC converter.

The power source of one or more of these clauses, wherein the bidirectional AC/DC transfers power from the electric machine to the DC power bus or transfers power from the DC power bus to the electric machine.

The power source of one or more of these clauses, wherein the connection assembly comprises an AC output line, and wherein the power source further comprises: an engine power bus, wherein the fuel cell assembly is electrically coupled to the engine power bus; and a bidirectional AC/DC converter, wherein the engine power bus is electrically coupled to the connection assembly with the bidirectional AC/DC converter.

The power source of one or more of these clauses, wherein the connection assembly comprises a DC output line, and wherein the power source further comprises: an engine power bus, wherein the fuel cell assembly is electrically coupled to the engine power bus; and a bidirectional AC/DC converter, wherein the electric machine is electrically coupled to the connection assembly through the bidirectional AC/DC converter and through the engine power bus.

The power source of one or more of these clauses, further comprising: an aircraft power bus; and an engine power bus, wherein the connection assembly comprises a DC output line and an AC output line, wherein the electric machine is electrically coupled to the aircraft power bus through the AC output line of the connection assembly, and wherein the engine power bus is electrically coupled to the aircraft power bus through the DC output line of the connection assembly.

The power source of one or more of these clauses, wherein power is transferred between the engine power bus and the electric machine through the connection assembly.

The power source of one or more of these clauses, wherein power is transferred between the engine power bus and the electric machine through the connection assembly and a bidirectional converter.

The power source of one or more of these clauses, wherein the fuel cell assembly is a solid oxide fuel cell assembly.

The power source of one or more of these clauses, wherein the engine is a gas turbine engine comprising a combustion section, wherein the fuel cell assembly comprises a fuel cell, wherein the fuel cell defines an outlet positioned to provide output products from the fuel cell to the combustion section.

The power source of one or more of these clauses, wherein the aircraft electrical load is external to the engine.

The power source of one or more of these clauses, further comprising a controller electrically coupled to the fuel cell assembly and the electric machine to control allocation of power from the fuel cell assembly and the electric machine to the power bus through the connection assembly with or without a bidirectional converter.

The power source of one or more of these clauses, further comprising an alternative power source electrically coupled to the power bus.

The power source of one or more of these clauses, wherein the alternative power source is a permanent magnetic generator, an auxiliary power unit, an energy storage system, an additional fuel cell, a power output from another power bus, or a combination thereof.

An aircraft power source assembly comprising: a gas turbine engine comprising one or more accessory systems; and a power source comprising: a connection assembly configured to electrically connect to the aircraft power bus; an engine power bus electrically coupled to the connection assembly and configured to be integrated into the gas turbine engine; a fuel cell assembly configured to be integrated into the gas turbine engine, the fuel cell assembly comprising a fuel cell group electrically coupled to the engine power bus and configured to provide a first power output to the engine power bus; and an electric machine configured to rotate with the gas turbine engine to generate a second power output during operation of the gas turbine engine when integrated into the gas turbine engine, the electric machine electrically coupled to the connection assembly such that both the first power output from the fuel cell group and a second power output from the electric machine are provided to the connection assembly during operating of the gas turbine engine.

The power source assembly of one or more of these clauses, wherein the engine power bus is a DC power bus, wherein the gas turbine engine comprises a plurality of accessory systems, and wherein the engine power bus distributes power to the plurality of accessory systems of the gas turbine engine when integrated into the gas turbine engine.

The power source assembly of one or more of these clauses, wherein the connection assembly comprises an AC output line, and wherein the power source further comprises: a DC/AC converter, wherein the engine power bus is electrically coupled to the connection assembly with the DC/AC converter.

The power source assembly of one or more of these clauses, wherein the connection assembly comprises a DC output line, and wherein the power source further comprises: an AC/DC converter, wherein the electric machine is electrically coupled to the connection assembly through the AC/DC converter and through the engine power bus.

The power source assembly of one or more of these clauses, wherein the connection assembly comprises a DC output line and an AC output line, wherein the electric machine is electrically coupled to the aircraft power bus through the AC output line of the connection assembly, and wherein the engine power bus is electrically coupled to the aircraft power bus through the DC output line of the connection assembly.

The power source assembly of one or more of these clauses, further comprising a controller electrically coupled to the fuel cell group and the electric machine to control allocation of power from the fuel cell group and the electric machine to the aircraft power bus through the connection assembly.

The power source assembly of one or more of these clauses, further comprising an alternative power source electrically coupled to the engine power bus.

We claim:

1. A power source for an aircraft having a gas turbine engine, comprising:
an electrical connection assembly;
a fuel cell assembly integrated into the gas turbine engine, electrically coupled to the connection assembly and configured to provide a first power output; and
an electric machine coupled to the gas turbine engine, electrically coupled to the connection assembly and configured to provide a second power output, wherein both the first power output from the fuel cell assembly and the second power output from the electric machine are provided to the connection assembly during operating of the gas turbine engine and wherein the connection assembly is electrically coupled to an aircraft electrical load.

2. The power source of claim 1, wherein the connection assembly is electrically coupled to a power bus, wherein the power bus distributes power to the aircraft electrical load.

3. The power source of claim 2, wherein the power bus is a DC power bus and wherein the electric machine is electrically coupled to the DC power bus through an AC/DC converter, wherein the AC/DC converter is a bidirectional AC/DC converter.

4. The power source of claim 3, wherein the bidirectional AC/DC converter transfers power from the electric machine to the DC power bus or transfers power from the DC power bus to the electric machine.

5. The power source of claim 1, wherein the connection assembly comprises an AC output line, and wherein the power source further comprises:
an engine power bus, wherein the fuel cell assembly is electrically coupled to the engine power bus; and
a bidirectional AC/DC converter, wherein the engine power bus is electrically coupled to the connection assembly with the bidirectional AC/DC converter.

6. The power source of claim 1, wherein the connection assembly comprises a DC output line, and wherein the power source further comprises:
an engine power bus, wherein the fuel cell assembly is electrically coupled to the engine power bus; and
a bidirectional AC/DC converter, wherein the electric machine is electrically coupled to the connection assembly through the bidirectional AC/DC converter and through the engine power bus.

7. The power source of claim 1, further comprising:
an aircraft power bus; and
an engine power bus, wherein the connection assembly comprises a DC output line and an AC output line, wherein the electric machine is electrically coupled to the aircraft power bus through the AC output line of the connection assembly, and wherein the engine power bus is electrically coupled to the aircraft power bus through the DC output line of the connection assembly.

8. The power source of claim 7, wherein power is transferred between the engine power bus and the electric machine through the connection assembly.

9. The power source of claim 7, wherein power is transferred between the engine power bus and the electric machine through the connection assembly and a bidirectional converter.

10. The power source of claim 1, wherein the fuel cell assembly is a solid oxide fuel cell assembly.

11. The power source of claim 1, wherein the engine is a gas turbine engine comprising a combustion section, wherein the fuel cell assembly comprises a fuel cell, wherein the fuel cell defines an outlet positioned to provide output products from the fuel cell to the combustion section.

12. The power source of claim 1, wherein the aircraft electrical load is external to the engine.

13. The power source of claim 2, further comprising a controller electrically coupled to the fuel cell assembly and the electric machine to control allocation of power from the fuel cell assembly and the electric machine to the power bus through the connection assembly with or without a bidirectional converter.

14. The power source of claim 2, further comprising an alternative power source electrically coupled to the power bus.

15. The power source of claim 14, wherein the alternative power source is a permanent magnetic generator, an auxiliary power unit, an energy storage system, an additional fuel cell, a power output from another power bus, or a combination thereof.

16. An aircraft power source assembly for an aircraft, the aircraft comprising an aircraft power bus, the aircraft power source comprising:
a gas turbine engine comprising one or more accessory systems; and
a power source comprising:
a connection assembly configured to electrically connect to the aircraft power bus;
an engine power bus electrically coupled to the connection assembly and configured to be integrated into the gas turbine engine;
a fuel cell assembly configured to be integrated into the gas turbine engine, the fuel cell assembly comprising a fuel cell group electrically coupled to the engine power bus and configured to provide a first power output to the engine power bus; and
an electric machine configured to rotate with the gas turbine engine to generate a second power output during operation of the gas turbine engine when integrated into the gas turbine engine, the electric machine electrically coupled to the connection assembly such that both the first power output from the fuel cell group and the second power output from the electric machine are provided to the connection assembly during operating of the gas turbine engine.

17. The power source assembly of claim 16, wherein the engine power bus is a DC power bus, wherein the gas turbine engine comprises a plurality of accessory systems, and wherein the engine power bus distributes power to the plurality of accessory systems of the gas turbine engine when integrated into the gas turbine engine.

18. The power source assembly of claim 16, wherein the connection assembly comprises an AC output line, and wherein the power source further comprises:
a DC/AC converter, wherein the engine power bus is electrically coupled to the connection assembly with the DC/AC converter.

19. The power source assembly of claim 16, wherein the connection assembly comprises a DC output line, and wherein the power source further comprises:
an AC/DC converter, wherein the electric machine is electrically coupled to the connection assembly through the AC/DC converter and through the engine power bus.

20. The power source assembly of claim 16, wherein the connection assembly comprises a DC output line and an AC output line, wherein the electric machine is electrically coupled to the aircraft power bus through the AC output line of the connection assembly, and wherein the engine power bus is electrically coupled to the aircraft power bus through the DC output line of the connection assembly.
